(19) United States
(12) Patent Application Publication
(10) Pub. No.: US 2015/0226080 A1
(43) Pub. Date: Aug. 13, 2015

(54) HydroQueen

(71) Applicant: Dorraine Marie Rooney, Wesley Chapel, FL (US)

(72) Inventor: Dorraine Marie Rooney, Wesley Chapel, FL (US)

(21) Appl. No.: 14/096,239

(22) Filed: Feb. 11, 2014

(51) Int. Cl. F01D 15/10; F03B 13/10

(52) U.S. Cl. CPC F01D 15/10; F03B 13/10

(57) ABSTRACT

The HydroQueen is a new concept in water turbines her vertically helical shaped paddles make her unique. She is a hydro turbine unit that can be varied in size to suit the needs of the client. The beauty in the simplicity of the HydroQueen allows us to make sustainable energy to most any site worldwide. Her helical blades will turn water current into useable energy.

### RELATED APPLICATIONS

There are no related pending applications to be cross referenced.

### BACKGROUND OF THE INVENTION

In a world that is in desperate need of sustainable energy I bring the HydroQueen. A definition at USPTO of B63B-Hydropower has to do with ships and waterborne vessels. I also find Class 441 Water Buoys (section 1 is the definition and section 2 as subsection within the subject).

The hydropower (impoundment or non impoundment) units have been good producers of energy, but not always friendly to the environment. The fact that out of 80,000 dams presently in the US only 3% are currently generating power (Johnson, 2012) shows how badly we need a product to work with what is currently going on.

### BRIEF SUMMARY OF THE INVENTION

This is a fixed buoy that uses water current running over a helically designed paddle that produces electricity and returns it to shore for use.

### BRIEF DESCRIPTION OF THE SEVERAL VIEWS OF THE DRAWING

Being that the HydroQueen is sizable and the area of current she is being placed in would be variables, the amount of power she can generate also varies.

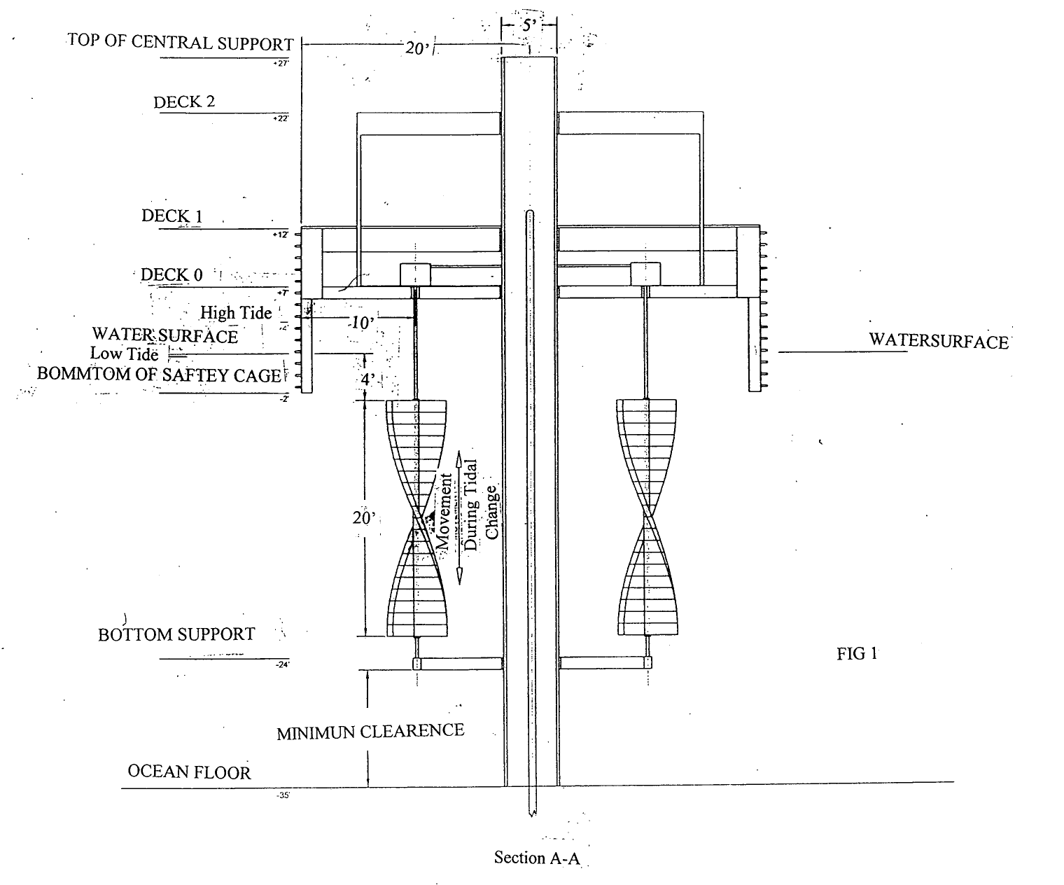

In FIG. 1, we can see a simple two paddle unit. If placed in a slow steady river one should expect to power an average home per month. If placed in a fast steady river one should expect to power 3 homes per month.

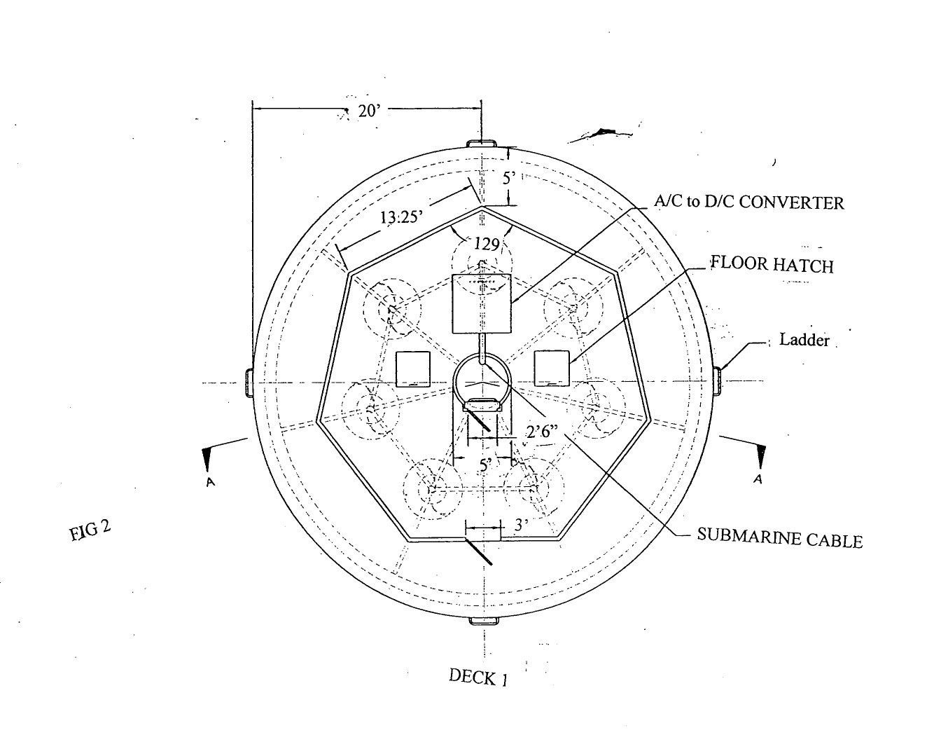

In FIG. 2 we see ‘deck 1’, this shows the maintenance and service hatches. We have set it up this way to keep animals and boaters from getting hurt.

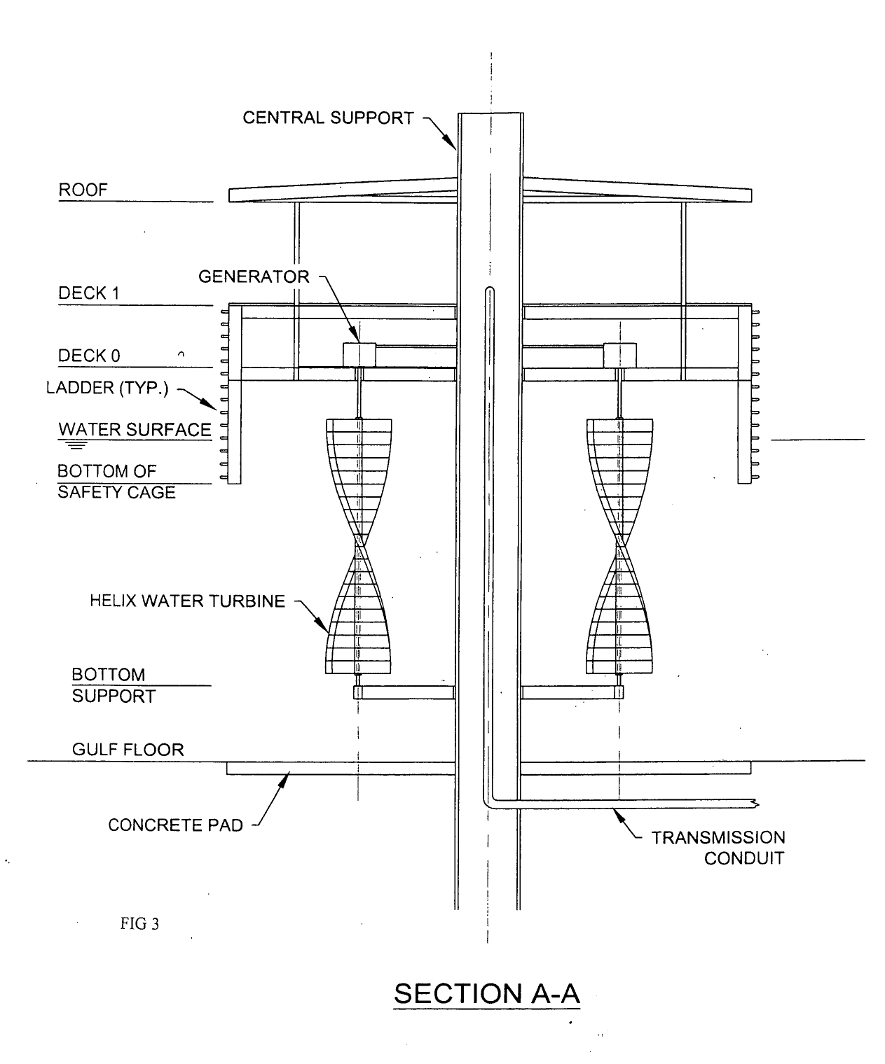

In FIG. 3 we see the HydroQueen in her full size; she would have 7 large paddles, a service deck and a protected sundeck. Her full size can be used in oceans, lakes or stronger rivers (i.e. the Mississippi, the Ganges, the Danube, etc).

### DETAILED DESCRIPTION OF THE INVENTION

The water current will spin the helically shaped paddle. The helically shaped paddle will spin the generator. The electricity will pass from ‘wild’ alternating current from the generator through to a rectifier to become direct current. Via a wire, the direct current will go to an inverter and be changed back to a straight alternating current. This current will then be sent to shore via submarine cable of copper or aluminum.

The top can be a roof or tube frame that contains lights, beacons, antenna, signage and solar panels where possible (beacons are for safety and will be determined by area authority). Ladders on the side of the unit will allow one to climb onto the main deck. The main deck will contain hatches for maintenance (for smaller units the second deck can be used as the main deck). The second deck will hold the sealed generator units, wire transfer cases, inverters fans, etc with poles from the roof or frame tying in for stability. The paddles tie into deck 2 and paddle hangers at the bottom. The paddles, depending on unit size, can go from 5-25 feet long and from 2½-15 foot wide. The paddle hangers at the base of the unit simply come forth to gently hold the paddle in place.

### REFERENCES

Johnson, K. (2012). With its large untapped capacity, small hydro is attracting policy makers' attention as job growth opportunity, Solar Today (Vol. 26) No. 1, retrieved from—http://www.hydro.org/wp-content/uploads/2012/02/2012-02-Solar-Today-Big-Potential-for-Small-Hydro.pdf

1. The HydroQueen can work in any body (lake, river, ocean, etc) or type (fresh, salt, brackish, etc) of water that contains continuous current. The HydroQueen can be sized for individual needs of the situation, each HydroQueen can hold from 1 to 7 paddles. Small units (1 paddle) are for small rivers or stream use—will generate from a campsite to small cabin monthly (depending on water current). Larger units (7 paddles) are built for larger rivers or lake or gulf or ocean situations—those will generate 5-500 (or more) homes per month depending on water current and size of unit. This is a fixed buoy that uses water current running over a helically designed paddle that produces electricity and returns it to shore for use.
